(19) United States
(12) Patent Application Publication
(10) Pub. No.: US 2026/0224928 A1
(43) Pub. Date: Aug. 6, 2026

(54) PROCEDURE FOR EXTINGUISHING A FIRE USING AN UNMANNED, PREFERABLY SELF-PROPELLED FIRE ENGINE

(71) Applicant: ROBERT STADLER INNOVATIV UG, Schwarzenbach am Wald (DE)

(72) Inventor: Robert STADLER, Schwarzenbach am Wald (DE)

(73) Assignee: ROBERT STADLER INNOVATIV UG, Schwarzenbach am Wald (DE)

(21) Appl. No.: 19/042,634

(22) Filed: Jan. 31, 2025

(51) Int. Cl. A62C 27/00; A62C 37/36; G05D 1/656; G05D 105/55

(52) U.S. Cl. CPC A62C 27/00; A62C 37/04; G05D 1/665; G05D 2105/55

(57) ABSTRACT

The present invention relates to a method for extinguishing a fire by means of an unmanned, preferably self-propelled fire engine comprising at least one mobile base frame that can be moved from one location to the next either fully automatically or by external intervention by a user, and at least one means for extinguishing and/or smothering fires, smouldering fires or other sources of fire that produce toxic gases, wherein the means for extinguishing and/or smothering is either connectable to an external extinguishing agent source or the vehicle at least partially comprises an extinguishing agent source, and further wherein the means for extinguishing and/or smothering is different from a watering vehicle.

The present invention comprises a method for extinguishing a fire using an unmanned, preferably self-propelled fire engine according to claim 1.

According to the invention, the method for extinguishing a fire comprises three steps: localising the fire and alerting an extinguishing vehicle, and then moving the extinguishing vehicle, either under its own power or by means of a cargo vehicle, such as a helicopter.

According to the invention, the unmanned, preferably self-propelled extinguishing vehicle comprises at least a drivable base frame which can be moved from one location to the next either fully automatically or by external intervention by a user, and at least one means for extinguishing and/or smothering fires, smouldering fires or other sources of heat that produce toxic gases, wherein the means for extinguishing and/or smothering can either be connected to an external extinguishing extinguishing agent source or the vehicle comprises at least in part an extinguishing agent source and further wherein the means for extinguishing and/or smothering is different from a watering vehicle.

The 2023 Canadian wildfires are a series of wildfires in Canada. They began in March 2023 and spread rapidly from May 2023, favoured by a severe drought, heat wave and consequential effects of climate change. Almost all provinces and regions of the country are affected. There are particularly extensive and numerous fires in Québec, Alberta, British Columbia, Saskatchewan, the Northwest Territories and Ontario; Manitoba, Nova Scotia, New Brunswick, Yukon and Newfoundland and Labrador are also affected.

In terms of area, the forest fire season is the worst in Canada since records began. By 21 Nov. 2023, 6652 fires had occurred, of which 331 were active and 84 were out of control at the time. They burned an area of around 185,000 km² by then. This is almost 2.5 times more than in the previous record season in Canada and is more than half the area of Germany (357,588 km²). On average, around 22,000 km² have burnt each year over the past ten years.

As a result, parts of Canada and the USA were hit by massive, hazardous air pollution, affecting more than 100 million people. By 22 August, almost 200,000 people had to be evacuated, more than ever before in Canada. Three firefighters and a helicopter pilot lost their lives fighting the fires.

The situation was exacerbated by the general shortage of firefighters and the fact that all provinces of Canada were affected at the same time, making it difficult to exchange personnel and equipment such as fire-fighting aircraft. The Canadian military was also deployed to fight the fires. In mid-June, around 5,000 firefighters from various countries, including the US, Chile, Portugal and Spain, were also helping with the extinguishing efforts. Since the large fires are difficult to extinguish, it is expected that the wildfire season will last well into the autumn. The height of the Canadian wildfire season usually occurs between June and August.

It is therefore one of the purposes of the present invention to at least control and ideally extinguish fires that are far away and similar situations, even without firefighters.

The preferably unnamed vehicle proposed here is a solution to the problem. For example, the vehicle is an aerosol extinguishing vehicle (also known as an exhaust gas extinguishing vehicle or turbolencer) is a fire engine that aerosolises (atomises) a liquid and blows it at high pressure and over long distances (up to 100 m) into a source of fire to extinguish a fire or to knock down toxic vapours and fire smoke and to. In this process, extinguishing water or extinguishing foam can be added to the exhaust gas stream of a movably arranged jet turbine or to the airflow of a conventional turbine (propeller).

According to at least one embodiment, the vehicle has at least one drive element, for example an electric motor or a combustion engine, by means of which the vehicle can be driven from a stationing location to a fire location or drives itself. A fuel tank can be installed in the vehicle that allows the vehicle to travel more than 10 km, preferably more than 100 km, without refuelling.

The extinguishing agent source may have an extinguishing pressure hose that is stored on the vehicle in a roll-up manner. Preferably, the hose is connected to an extinguishing agent reservoir on or in the vehicle or externally. For example, the hose is a fire hose. Preferably, the hose and/or a pressure pump on or in the vehicle is designed for an operating pressure of up to 17 bar and is also set up and intended for this. For example, the test pressure for A and F hoses is 12 bar and for B, C and D hoses 16 bar. The burst pressure, for example, is 25 bar; i.e. new hoses must preferably withstand 24 bar without bursting.

A fire extinguisher can be located at the end of the hose. An extinguishing agent pump can be secured either to the engine or to a further pump pressure generating unit of the vehicle.

Preferably, the hose is rolled up on a drum with a diameter of at least one metre, preferably at least 5 m. The drum can be part of the vehicle.

According to at least one embodiment, it has at least one hose reel onto which the hose can be rolled up and unrolled by itself or by the application of mechanical force.

According to at least one embodiment, this has at least one controller element, which transfers the data relevant for fighting the fire, such as location, surface area, points of danger or similar, to a control and/or a drive element, and the control is set up and intended to control the drive element in such a way that it moves fully or semi-automatically, preferably without initial intervention by a monitor or user, to the location of the source the source of the fire.

According to at least one embodiment, after arriving in the vicinity of the source of the fire, the vehicle positions itself, preferably fully automatically, at the source of the fire in such a way that it is contained or extinguished by the vehicle, preferably fully automatically.

According to at least one embodiment, after a fluid-tight connection of the means for extinguishing and/or smothering to a fluid tank and/or an extinguishing fluid system, the vehicle moves, preferably fully automatically, along the source of the fire in order to contain or extinguish it, by means of a turbine installed on the vehicle, and this turbine diverts part of the fluid pressure in order to drive it. In this case, the actual engine of the vehicle can be switched off.

The extinguishing process can be carried out in rows and columns. To do this, the vehicle can be satellite-controlled.

According to at least one embodiment, the vehicle has at least one sensor system by means of which characteristics of the source, such as location, surface area, heat, points of danger or the like, can be detected, so that these values are passed on to the control unit, so that fully automatic containment or extinguishing of the source is possible without further influence from an operator or monitor. For example, depending on the requirements for extinguishing the fire, more than one vehicle is automatically or manually deployed.

This could mean a series of at least two vehicles described here, which preferably drive fully automatically to the cooker. Once the cooker has been registered in the alarm system, either fully automatically or by the monitor, everything can happen fully automatically. It is also conceivable that a cooker can also be recognised fully automatically by a monitoring system.

Satellites or similar devices that recognise the cooker in real time or from a certain size could be used for this.

According to at least one embodiment, the fire engine either by means of the operation of an operator of the fire engine or fully automatically after arriving at the scene of the fire, lays its hose connection to a water source along the side of a road or path, along which the fire engine is brought to a halt, so that a fire engine driving behind it, for example of the same type as described here in accordance with the invention, does not have to drive over the hose laid to the rear or be obstructed by it.

According to at least one embodiment, a pressure compressor unit is mounted on at least one of the fire engines described here, in order to be able to maintain an output pressure from a fire-fighting water source at least partially, preferably completely. In other words, the pressure loss is at least partially maintained at at least one point, provided that several fire engines are arranged one behind the other, so that a fire engine cascade can be created.

For example, the hose diameter of the fire engine is at least 5 inches, preferably at least 10 inches, and particularly preferably at least 11 or at least 12 inches, for example.

Water is therefore forced under high pressure from the fire engine through a fire hose, as described here, so that high-pressure spraying can take place.

In addition to the enormous amount of water that is pressed and hurled from the end of the hose towards the source under such a hose size, in particular under high pressure, the source is therefore usually not only actually extinguished, but often also smothered.

For the purposes of the invention, ‘high pressure’ means a pressure of at least 5 bar, preferably at least 10 bar, in particular at least 40 and at most 200 bar, applied to the extinguishing agent, for example the extinguishing water.

In this way, the fire engine can form a so-called high-pressure extinguishing system.

A high-pressure extinguishing system (abbreviated HDL, also known as a maximum pressure extinguishing system, especially in Austria) is designed to achieve the greatest possible extinguishing effect with as little water as possible. The principle of a high-pressure extinguishing system is that ‘the finer the water droplets, the faster the water evaporates and the better the extinguishing effect'. Water that does not evaporate is extinguish-technically speaking ‘waste’ and is responsible for the infamous water damage caused by a small fire.

Unlike impulse extinguishing systems, high-pressure extinguishing systems deliver a constant jet. However, both work at pressures of over 100 bar, depending on the type. The ultra-fine atomisation suddenly massively increases the surface area of the extinguishing agent (water with or without foaming agent), resulting in faster evaporation. Special features are the fast and highly efficient evaporation, which removes the enormous amount of heat of 2.3 MJ per litre of water from the environment. The air is also displaced when it comes into contact with the flames due to the immediate evaporation (approx. 1600-fold increase in the volume of the original water droplet), which makes it possible to quickly contain the flames. In addition, there is an enormous cooling effect and efficient shielding against radiant heat for surrounding fire loads and people in the vicinity.

It is conceivable that if at least two of the fire engines presented here are supplied simultaneously, for example, from a single source of extinguishing agent, such as a lake or a hydrant, or in succession in a kind of series connection, several monitors can be used to fight a fire with approximately the same pressure conditions.

In addition, in the sense of registration, the term ‘fire engine’ is understood to mean any moving or movable extinguishing device. The term ‘fire engine’ therefore not only includes vehicles with their own motorised drive, for example a diesel, petrol or other combustion engine and/or electric motor, but also fire-fighting trailers or separate extinguishing devices that do not have their own means of movement and are, for example, first transported to the vicinity of the source of the fire by a helicopter or other aerial device.

If a vehicle's sensors detect that additional vehicles are needed on site to contain or extinguish the fire, at least one additional vehicle is preferably set in motion or starts up automatically.

According to at least one embodiment, after the containment or extinguishing process has been completed, the vehicle automatically returns to a resting location, for example a fire station.

According to at least one embodiment, GPS data or other geodata can be used to move the vehicle.

According to at least one embodiment, extinguishes or dawns when proceeding to contain or extinguish a (fire) source, wherein, after reporting a source to a reporting centre, possibly under initialisation by a supervisor, a fire engine according to claim 1 enters a source.

The present invention also includes a roll-off winch for rolling off a fire hose from an aircraft.

According to at least one embodiment, the unwinding winch for unwinding a fire hose from an aircraft, such as a helicopter, comprises at least one unwinding axle, around which the fire hose can be at least partially unwound and rewound, and at least one fastening device for releasably fastening the unwinding axle to the fastening device, which is characterised in that, in addition to fastening the unwinding axle, the fastening device, the fastening device also has a gyroscopic stabilisation mounting for the roll-off axle, so that a gyroscopic stabilisation and thus a directional stabilisation of the roll-off axle can be generated.

According to at least one embodiment, the roller winch for rolling out a fire hose from an aircraft is characterised in that the gyroscopic stabilisation mounting keeps the rolling axis essentially directionally constant by means of a displacement of weights, independently of the inclination of the aircraft.

According to at least one embodiment, the unreeling winch for unreeling a fire hose from an aircraft is characterised in that the unreeling axis itself is a stabilisation axis in the sense of gyroscopic stabilisation.

According to at least one embodiment, the unreeling winch for unreeling a fire hose from an aircraft includes a transport system which includes at least the unreeling winch and at least one extinguishing device for supplying air to the latter at the source of the fire.

The invention described here is presented in more detail below with the aid of a figure and the associated description.

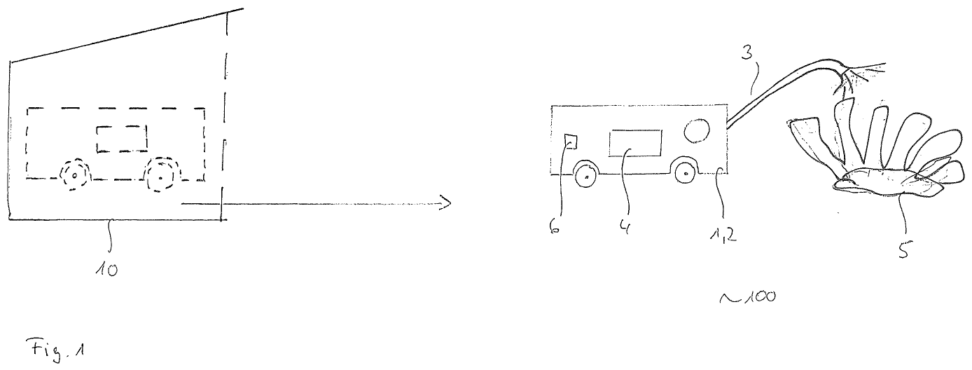

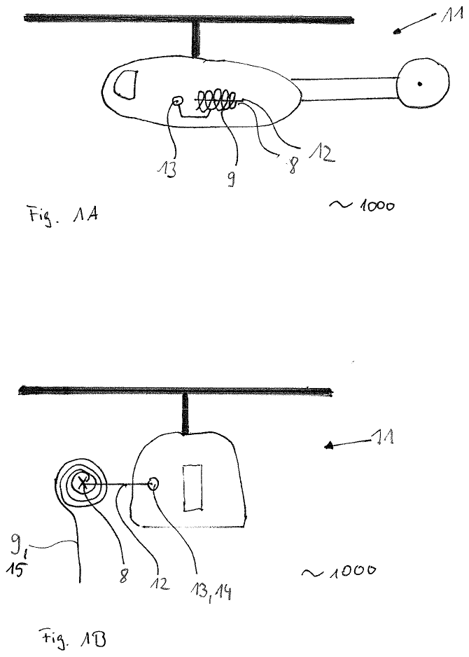

FIG. 1 shows the unmanned, preferably self-propelled fire engine 1 described here, which comprises at least a mobile base frame 2 that can be moved from one location to the next either fully automatically or by external intervention by a user, and at least one means 3 for extinguishing and/or smothering fires, smouldering fires or other sources 5 of toxic gases, the means 3 for extinguishing and/or smothering can either be connected to an external extinguishing agent source or the vehicle 1 comprises at least in part an extinguishing agent source and further wherein the means 3 for extinguishing and/or smothering is different from a watering vehicle.

The vehicle 1 has at least one drive element 4, for example an electric motor or an internal combustion engine, by means of which the vehicle 1 can be driven or drives itself from a stationing location to a fire location 5.

The fire engine 1 also has at least one hose reel on which the hose can be rolled up and unrolled either by itself or by the application of mechanical force.

It also has at least one controller element 6, which transmits the data relevant for fighting the fire, such as location, surface area, points of danger or similar, to a control and/or a drive element 4, and the control is set up and designed to control the drive element 4 in such a way that it moves fully or semi-automatically, preferably without initial intervention by a supervisor or user, to the location of the oven 5.

After arriving in the vicinity of the source of the fire, the vehicle 1 positions itself, preferably fully automatically, at the source of the fire in such a way that it is contained or extinguished by the vehicle 1, preferably fully automatically.

FIG. 1 also shows the fire engine 1, how, after a fluid-tight connection of the agent 3 for extinguishing and/or smothering to a fluid tank and/or to an extinguishing fluid system, the vehicle 1 moves, preferably fully automatically, along the source 5 in order to contain or extinguish it, by means of a turbine 7 installed on the vehicle 1, and how this turbine 7 diverts part of the fluid pressure for its drive.

In this case, the vehicle 1 has at least one sensor system by means of which characteristics of the source 5, such as location, surface area, heat, points of danger or similar, can be detected, so that these values are passed on to the control unit, so that fully automatic containment or extinguishing of the source 5 is possible without further influence from an operator or supervisor.

After the containment or extinguishing operation has been completed, vehicle 1 then automatically returns to a resting location, for example a fire station 10, whereby GPS data or other geodata can be used to move the vehicle 1.

FIG. 1 also shows a method 100 for containing or extinguishing a source 5 of fire, in which, after a source 5 has been reported to a control centre, possibly with the initialisation by a supervisor, a fire engine 1 according to claim 1 contains or extinguishes the source.

FIG. 1A shows in a side view the unwinding winch 8 for unwinding a fire hose 9 from an aircraft 11, such as a helicopter, wherein the unwinding winch 8 comprises at least one unwinding axle 12, around which the fire hose 9 can be at least partially unwound and rewound, and at least one fastening device 13 for releasably fastening the unwinding axle 12 to the fastening device 13, which is characterised in that the fastening device 13, in addition to fastening the unwinding axle 12, also has a gyroscopic stabilising bearing 14 for the unwinding axle 12, so that a gyroscopic stabilisation and thus a directional stabilisation of the unwinding axle 12 can be generated.

In addition, it can be seen from FIG. 1A that the gyroscopic stabilisation mounting 14 keeps the rolling axis 12 essentially directionally constant by means of a displacement of weights independently of the inclination of the flying apparatus 11, and that the rolling axis 12 is itself simultaneously a stabilisation axis in the sense of gyroscopic stabilisation.

FIG. 1A also shows a transport system 1000, which comprises at least the winch 8 and at least one extinguishing device 15 for transporting air to a fire.

FIG. 1B shows all the above features in a rear view of the flying apparatus 11.

### LIST OF REFERENCE DESIGNATIONS

1 Fire engine
2 Base frame
3 Means of extinguishing and/or smothering fires
4 Drive element
5 Site of fire, source of fire
6 Controller element
7 Turbine
8 Unwinder
9 Fire hose
10 Equipment storage
11 Aircraft
12 Unwinder axle
13 Mounting device
14 Gyroscopic stabilisation mounting
15 Extinguishing device
100 Procedure
1000 Transport system

1. Method (100) for extinguishing a fire (5), comprising the steps of:
localising the fire (5) and alerting an extinguishing vehicle (1),
and subsequent travel of the extinguishing vehicle (1), either under its own power or by means of a cargo transport, such as a helicopter, wherein the extinguishing vehicle (1) is constructed as follows:
unmanned, preferably self-propelled fire-fighting vehicle (1), comprising
at least one mobile base frame (2) which can be moved from one location to the next either fully automatically or by external intervention by a user,
at least one means (3) for extinguishing and/or smothering fires, smouldering fires or other sources of heat (5) containing toxic gases,
characterised in that
the means (3) for extinguishing and/or smothering can either be connected to an external extinguishing agent source or the vehicle (1) at least partially comprises an extinguishing agent source and further wherein the means (3) for extinguishing and/or smothering is different from a watering vehicle.

2. A method (100) according to claim 1,
characterised in that
the vehicle (1) has at least one drive element (4), for example an electric motor or an internal combustion engine, by means of which the vehicle (1) can be driven or drives itself from a stationing location to a fire location (5).

3. A method (100) according to claim 1,
characterised in that
it comprises at least one hose reel onto which the hose can be rolled and unrolled by itself or by the application of mechanical force.

4. A method (100) according to claim 1,
characterised in that
it has at least one controller element (6) which transmits data relevant for fire fighting, such as location, surface area, points of risk or similar, to a control and/or a drive element (4), and the control is set up and intended to control the drive element (4) in such a way that it moves fully or semi-automatically, preferably without initial intervention by a monitor or user, to the location of the source (5).

5. A method (100) according to claim 1,
characterised in that
after arriving in the vicinity of the source (5), the vehicle (1) positions itself, preferably fully automatically, at the source so that it is contained or extinguished by the vehicle (1), preferably fully automatically.

6. A method (100) according to claim 1,
characterised in that
after a fluid-tight connection of the means (3) for extinguishing and/or smothering to a fluid tank and/or to an extinguishing fluid system, the vehicle (1) moves, preferably fully automatically, along the source (5) in order to contain or extinguish it, by means of a turbine (7) installed on the vehicle (1), and this turbine (7) diverts part of the fluid pressure.

7. A method (100) according to claim 1,
characterised in that
the vehicle (1) has at least one sensor system by means of which properties of the source (5), such as location, surface area, heat, danger points or similar, can be detected, so that these values are passed on to the control unit, so that fully automatic containment or extinguishing of the source (5) is possible without further influence from an operator or supervisor.

8. A method (100) according to claim 1,
characterised in that
after the containment or extinguishing operation has been completed, the vehicle (1) returns fully automatically to a resting place, for example a fire station (10).

9. A method (100) according to claim 1,
characterised in that
GPS data or other geodata can be used to navigate the vehicle (1).
